(19) United States
(12) Patent Application Publication
(10) Pub. No.: US 2024/0305216 A1
(43) Pub. Date: Sep. 12, 2024

(54) Arrangement For Current Sharing Of Parallel-Connected Inverters

(71) Applicant: ABB Schweiz AG, Baden (CH)

(72) Inventors: Veli-Matti Leppanen, Helsinki (FI); Peter Muszynski, Helsinki (FI); Tero Viitanen, Helsinki (FI)

(21) Appl. No.: 18/599,360

(22) Filed: Mar. 8, 2024

(30) Foreign Application Priority Data
Mar. 10, 2023 (EP) 23161227.6

(51) Int. Cl. H02M 7/493; H02M 1/00; H02M 7/521

(52) U.S. Cl. CPC H02M 7/493; H02M 1/0009; H02M 7/521

(57) ABSTRACT

A power inverter system includes switching mode inverter legs connected in parallel between a common DC input and, via leg output inductors, a common phase output to feed a phase output current to a common load. The commutations of the parallel-connected inverter legs are initiated by essentially simultaneous commutation commands. The leg output current is sensed before and after a commutation in each of the parallel-connected inverter legs to obtain a pre-commutation current value and a post-commutation current value. Alternatively, a voltage pulse over the leg output inductor is sensed in each of the parallel-connected inverter legs during the commutation. A current sharing between the parallel-connected inverter legs is balanced by means of adjusting switching instants of main switches of the parallel-connected inverter legs for subsequent commutation autonomously in each of the parallel-connected inverter legs based on a difference between the pre-commutation and the post-commutation current values or based on the sensed voltage pulse of the respective parallel-connected inverter leg.

### TECHNICAL FIELD

The present invention relates to parallel-connected power inverters, and more particularly to a current sharing of parallel-connected power inverters.

### BACKGROUND

A dc-ac converter, also known as an inverter, converts dc power to ac power at desired output voltage and output frequency. The inverter therefore can be operated as an adjustable-frequency voltage source. The dc power input to the inverter may be obtained from an existing power supply network through a rectifier or from a battery, fuel cell, photovoltaic array, etc. The filter capacitor(s) across the input terminals of the inverter provides a fairly constant dc-link voltage. A configuration of ac to dc converter and de to ac inverter may be called a dc-link converter.

In some situations, a power inverter with an increased output power capability is implemented by connecting a plurality of inverter units in parallel with one another to feed the same load through output reactors. The parallel-connected inverter units may receive simultaneous and similar control signals to provide a desired output of the power inverter. However, due to parameter differences of switch components and differing impedances in parallel branches, the currents between the units can be unequal in magnitude. Such a current imbalance can stress the components unevenly and wear switch components with higher current prematurely. A higher current in a switch component can result in a higher dissipated power and, further, a higher temperature of the component.

Current imbalance has been addressed by modifying switch control pulses in order to balance the currents. The control pulses can be modified by delaying a turn-on time instant for a switch that has the highest current or by delaying turn-off time instants for a switch that has the smallest current. One such method is disclosed in EP0524398. In these solutions, the conducting times of the parallel components are modified to equalize stresses to the switch components on the basis of measured inverter unit currents.

U.S. Pat. No. 8,432,714 discloses a method for balancing load between parallel-connected inverters wherein temperatures of each output leg of each inverter are determined and the switching instructions for one or more of the parallel inverters are modified for controlling the temperatures of the output legs.

WO2017079125A1 discloses a method wherein the output voltages of all the parallel connected power devices are measured, and the measuring results are used for mitigating timing differences during output voltage state changes caused e.g. by gate driver circuit and switching component parameter tolerances.

U.S. Pat. No. 7,068,525 discloses a method of operating multiple parallel-connected inverters by regulating the individual currents of the inverters separately.

### SUMMARY

An object of the present invention is to provide an improved power inverter system having two or more parallel-connected inverter legs. The power inverter system and preferred embodiments are disclosed in the claims.

An aspect of the invention is a power inverter system, comprising:
two or more switching mode inverter legs connected in parallel between a common DC input and a common phase output to feed a phase output current to a common load, the phase output current being formed by combined leg output currents of the parallel-connected inverter legs, wherein commutations of the parallel-connected inverter legs are initiated by essentially simultaneous commutation commands,
a control arrangement configured to balance current sharing between the parallel-connected inverter legs by means of adjusting switching instants of main switches of the parallel-connected inverter legs,
wherein the control arrangement is configured to sense the leg output current before and after a commutation in each of the parallel-connected inverter legs to obtain a pre-commutation current value and a post-commutation current value, and wherein the control arrangement is configured to adjust switching instants of the main switches for subsequent commutation autonomously in each of the parallel-connected inverter legs based on a difference between the pre-commutation and the post-commutation current values of the respective parallel-connected inverter leg to control the difference towards zero, the difference being representative of a timing difference between switching instants of the respective parallel-connected inverter leg and at least one of the other parallel-connected inverter legs.

In an embodiment, if a sign of the difference between the pre-commutation and the post-commutation current values is negative, the control arrangement is configured to adjust switching instants for subsequent commutation so as to increase the negative difference towards zero, and wherein, if a sign of the difference between the pre-commutation and the post-commutation current values is positive, the control arrangement is configured to adjust switching instants for subsequent commutation so as to decrease the positive difference towards zero.

In an embodiment, the sign of the difference between the pre-commutation and the post-commutation current values indicates whether the switching instant of the parallel-connected inverter leg is earlier or later relative to a corresponding switching instant of at least one of the other parallel-connected inverter legs, and wherein the control arrangement is configured to advance the switching instants of the main switch, if the sign of the difference between the pre-commutation and the post-commutation current values indicates the switching instant of the parallel-connected inverter leg is later relative to a corresponding switching instants of at least one other parallel-connected inverter leg.

Another aspect of the invention is a power inverter system, comprising:
two or more switching mode inverter legs connected in parallel between a common DC input and, via leg output inductors, a common phase output to feed a phase output current to a common load, the phase output current being formed by combined leg output currents of the parallel-connected inverter legs, wherein commutations of the parallel-connected inverter legs are initiated by essentially simultaneous commutation commands,
a control arrangement configured to balance current sharing between the parallel-connected inverter legs by means of adjusting switching instants of main switches of the parallel-connected inverter legs,
wherein the control arrangement is configured to sense a voltage pulse over the leg output inductor in each of the parallel-connected inverter legs during the commutation, and wherein the control arrangement is configured to adjust the switching instants autonomously in each of the parallel-connected inverter legs based on the duration and/or sign of the sensed output inductor voltage pulse or an integral of the voltage pulse of the respective parallel-connected inverter leg to control the magnitude and direction of a commutation-induced current difference towards zero.

In an embodiment, the integral of the sensed voltage pulse represents a magnitude of the commutation-induced current difference in the parallel-connected inverter leg.

In an embodiment, the duration of the sensed voltage pulse represents a timing difference of a switching instant of the parallel-connected inverter leg relative to a corresponding switching instant of at least one other parallel-connected inverter leg.

In an embodiment, the sign of the sensed voltage pulse indicates whether the switching instant of the parallel-connected inverter leg is earlier or later relative to a corresponding switching instant of at least one other parallel-connected inverter leg.

In an embodiment, the control arrangement is configured to advance the switching instant of the parallel-connected inverter leg, if the sign of the voltage pulse indicates the switching instant of the parallel-connected inverter leg is later relative to a corresponding switching instant of at least one other parallel-connected inverter leg; and wherein the control arrangement is configured to delay the switching instant of the parallel-connected inverter leg, if the sign of the voltage pulse indicates the switching instant of the parallel-connected inverter leg is earlier relative to a corresponding switching instant of at least one other parallel-connected inverter leg.

In an embodiment, the control arrangement is configured to carry out the sensing and adjustment of the switching instants during all commutations or during a selected portion of the commutations.

In an embodiment, the control arrangement is configured to carry out the sensing at each turn-on and turn-off of the main switches.

In an embodiment, the control arrangement is configured to adjust the switching instants of the main switches to control the commutation-induced current difference or a timing difference in an individual commutation towards zero but not to zero thereby causing a stepwise swing of a phase output voltage of the inverter system during an individual commutation.

In an embodiment, the control arrangement is configured to adjust the switching instant of the main switches to control the commutation-induced current difference or a timing difference in an individual commutation towards zero to a predetermined non-zero value that is equal for turn-on and turn-off of the main switches, thereby causing a stepwise swing of a phase output voltage of the inverter system during an individual commutation.

In an embodiment, the control arrangement comprises a leg-specific controller for each of the two or more parallel-connected inverter legs to adjust the switching instants of the main switches.

In an embodiment, the power inverter system comprises two or more inverters, each of the inverters comprising one or more inverter phase legs, wherein the parallel-connected inverter legs are the corresponding inverter phase legs of the two or more inverters modules connected in parallel.

In an embodiment, the control arrangement comprises inverter-specific switching controllers for the two or more inverters, each of the inverter-specific switching controllers being configured to provide the autonomous adjustment of switching instants for each of the inverter phase legs of the respective inverter.

### BRIEF DESCRIPTION OF THE DRAWINGS

In the following the invention will be described in greater detail by means of exemplary embodiments with reference to the accompanying drawings, in which:

FIG. 1 is a block diagram that schematically illustrates an exemplary inverter system having a plurality of parallel-connected inverters;

FIG. 2 is a schematic of an exemplary inverter system having two parallel-connected inverters;

FIG. 3 is a schematic block diagram of an exemplary embodiment of a switching controller;

FIGS. 4A-4G illustrate an example of principal waveforms for the gate control signals at turn-on and turn-off off for upper switches and for corresponding leg output currents, voltages across output inductors and an inverter output voltage of two parallel-connected inverter legs of FIG. 2;

FIG. 5 is a flow diagram illustrating an exemplary procedure for an autonomous switching timing adjustment of parallel-connected inverter legs based on measuring output current before and after the commutation; and

FIG. 6 is a flow diagram illustrating an exemplary procedure for an autonomous switching timing adjustment of parallel-connected inverter legs based on measuring a voltage across an output inductor during the commutation.

### DETAILED DESCRIPTION

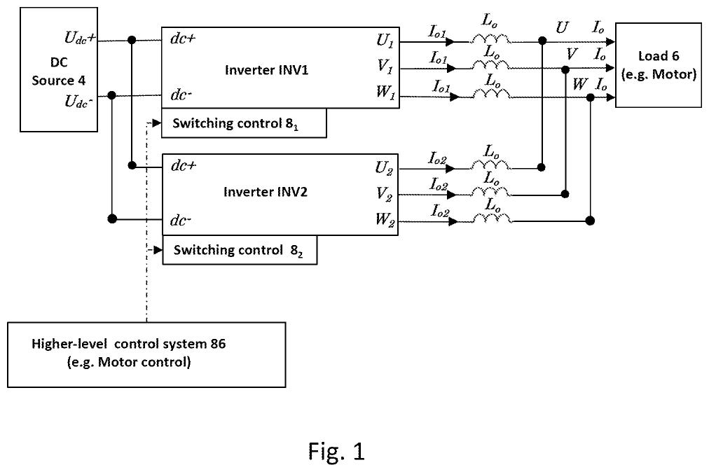

FIG. 1 shows a block diagram that schematically illustrates an exemplary inverter system having a plurality of (i.e., two or more) inverters INV1, INV2, . . . , INVN connected in parallel from their DC side (e.g., DC link) input terminals (e.g., dc+, dc−) and their AC side output terminals (e.g., U₁, V₁, W₁, U₂, V₂, W₂). In the illustrated example, the inverters INV1 and INV2 are three-phase inverters providing three phase outputs U₁, V₁, W₁ and U₂, V₂, W₂, but it should be appreciated that parallel-connected inverters may be implemented as single-phase inverters, or generally include any number of inverter phases or phase legs. The parallel-connected inverters are fed by a common DC voltage source 4 with voltage U_{dc}, and inverters are feeding a common AC load 6. A typical application area of the parallel-connected inverters fed by a common DC voltage source 4 is an electric motor drive having an AC electric motor as a common load 6. It should be noted that the load 6 does not have to be of AC type. It can be DC as well, for example a battery energy storage or similar. Parallel connected inverter phase legs apply this invention similarly, regardless of the load type. There is a non-zero impedance at each phase output of the inverters, represented by inductances Lₒ in FIG. 1. The output inductances Lo may be intentionally implemented (e.g., an inductor, a coil, a choke, etc.) or it may be just some leakage impedance of practical components and materials, such as cabling. The output inductances Lo may be substantially equal, but it must not necessarily be so. The corresponding phase outputs U₁, U₂, V₁, V₂, and W₁, W₂ of the parallel-connected inverters INV1 and INV2 are connected through the output inductances Lo to the common phase outputs U, V, and W, respectively. The corresponding phase outputs U₁, U₂, V₁, V₂, and W₁, W₂ of the parallel-connected inverters INV1 and INV2 may be connected together right after the output inductances Lo, and a single cable or multiple cables per phase U, V, and W may be used to connect the phase outputs to the load 6. Alternatively, each parallel-connected inverter INV1 and INV2 can be connected by means of its own cabling to the load 6, and the phase outputs U₁, U₂, V₁, V₂, and W₁, W₂ can be connected in parallel first at the terminals of the load 6. Output phase current Io of each phase U, V, W supplied to the load 6 is formed by combining phase output currents Iₒ₁ and Iₒ₂ of the respective phase outputs U₁, U₂, V₁, V₂, and W₁, W₂ of the parallel-connected inverters INV1 and INV2. The common DC supplied parallel-connected inverters INV1 and INV2 can be controlled to act like one high power inverter. This can be achieved by controlling the parallel inverters with essentially same control commands.

Each inverter INV1 and INV2 may have one or more half bridge legs, which can be functionally independent of each other or parallel connected inside an inverter (INV1 or INV2). The functionally similar bridge legs of the same phase of different inverters (INV1 and INV2) are connected in parallel with one another. Each bridge circuit can include a plurality of electronic switching elements or devices (e.g. insulated gate bipolar transistors (IGBTs)) that operate in a switch mode, meaning that that they are controlled to transition from a blocking state (OFF state) to a conducting state (ON state), and vice-versa, by providing control pulses (often called switching control signals or gating signals) at a high switching frequency. In a PWM modulation scheme, the width of control pulses provided to the control inputs of the switching devices is varied to provide a desired output of the inverter. The parallel-connected inverters INV1 and INV2 may have a common switching control (e.g., as a part of the higher level control 86 in FIG. 1) that provides switching signals or gating signals to operate switching devices of all inverters, or each parallel-connected inverter INV1 and INV2 may have a dedicated switching control unit 8₁ and 8₂ that provides switching signals or gating signals to operate switching devices of the respective inverter, as illustrated in FIG. 1. Alternatively, the control may be distributed among a common switching control unit and inverter-specific switching control units. In the latter cases, the inverters may be normal inverters (i.e., that can be used as single units) that can be connected in parallel as such. In embodiments, the switching control(s) 8₁ and 8₂ of the parallel-connected inverters INV1 and INV2 may be controlled by a higher-level control system 86 with simultaneous and essentially similar control signals or commands.

In embodiments, the higher-level control system 86 may be an electric motor control system or similar. It can also include a common PWM generation function (for example, a PWM modulator) for all system elements and phases.

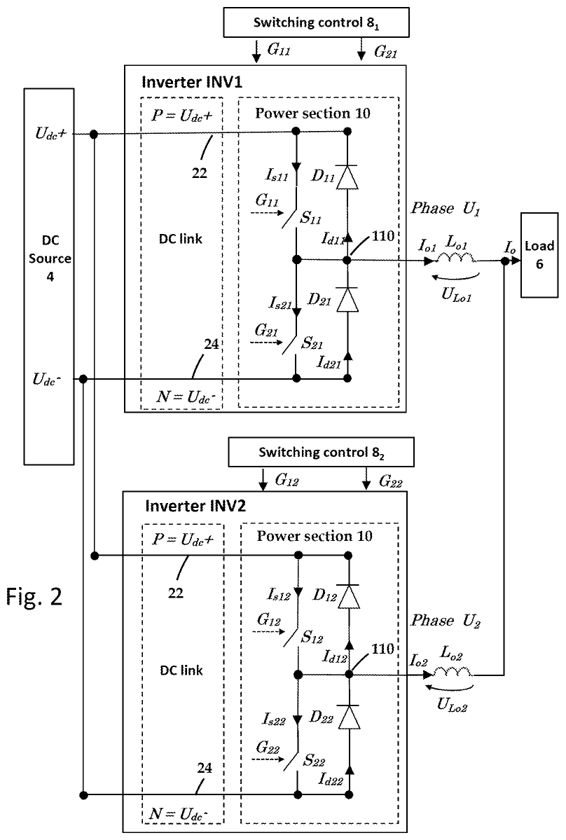

The schematic of an exemplary inverter system (e.g., single-phase inverter system) having two inverters INV1 and INV2 connected in parallel is illustrated in FIG. 2 and described herein in order to alleviate comprehending operation and configuration of embodiments of the invention in relation to exemplary basic parallel-connected inverters. It is not intended to limit embodiments of the invention to the described and illustrated exemplary inverters. It shall be appreciated that the current sharing control according to embodiments of the invention is universally applicable to any number of parallel inverters, any type of inverters and their derivates and modifications regardless the specific design, configuration, and operation variations of an inverter from the exemplary inverter.

The parallel-connected inverters INV1 and INV2 may preferably be identical inverters having the same configuration and operation. The inverters INV1 and INV2 comprise power switching sections 10, such as half-bridge circuits, and dc-link rails 22 (positive dc-link potentials P) are connected to a first voltage terminal U_{dc+} of the common DC power source 4, and dc-link rails 24 (negative dc-link potentials N) are connected to a second voltage terminal U_{dc-} of the common DC power source 4. The output node 110 of each power switching section 10 can be connected through the corresponding output inductance Lₒ₁ and Lₒ₂ to the corresponding phase terminal of an ac load 6, such as an ac motor or ac grid or any applicable electric load. and thereby the corresponding phase outputs 110 of the inverters INV1 and INV2 (e.g., phase legs U₁ and U₂) are connected in parallel via Lₒ₁ and Lₒ₂. It should be appreciated that although a half-bridge inverter is illustrated as an example herein, the inverter may have other configurations, particularly a full-bridge configuration.

The common dc power input to the parallel-connected inverters INV1 and INV2 may be obtained from any kind of a dc power source 4, such as from an existing power supply network through a rectifier, or from a battery, fuel cell, photovoltaic array, etc. It shall be appreciated that dc-link 2 may be provided in several forms and may have a number of voltages and other attributes. It shall also be appreciated that the voltage difference between positive and negative dc-link rails is flexible, depending on how the dc-link 2 is fed. It shall be further appreciated the term bus may be utilized in place of the term link such that, for example, references to a dc-link are understood to encompass a dc-bus and vice versa.

It should be appreciated that although a single-phase inverter is illustrated as an example herein, an inverter may be implemented as a three-phase inverter, or generally include any number of inverter phases or phase legs. For example, inverters INV1 and INV2 illustrated in FIG. 2 may be implemented as three-phase inverters including a power section 10_{U}, 10_{V} and 10_{W} for each phase or phase leg U₁, U₂, V₁, V₂, W₁ and W₂, respectively. Operation and configuration of the other phases or phase legs V₁, V₂, W₁ and W₂ of the inverters INV1 and INV2 can be identical to the operation and configuration described for the phases or phase legs U₁ and U₂ above.

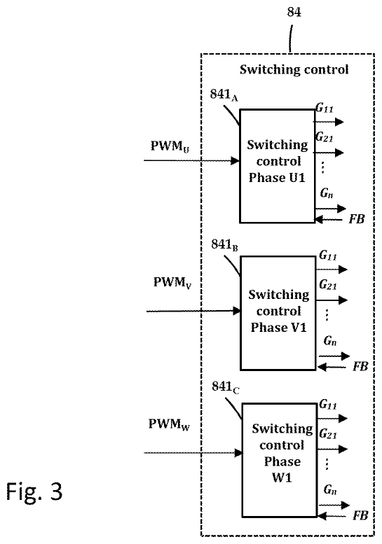

In embodiments, three-phase inverters INV1 and INV2 may each comprise a dc-link with dc-link capacitors (e.g., a dc-link illustrated in FIG. 3) common to all the power sections 10_{U}, 10_{V} and 10_{W} of the respective inverter.

In embodiments, all power sections 10_{U}, 10_{V} and 10_{W} of phase legs U₁, V₁ and W₁ in the inverter INV1 may be controlled by the same inverter-specific switching controller 8₁. Similarly, in embodiments, all power sections 10_{U}, 10_{V} and 10_{W} of phase legs U₂, V₂ and W₂ in the inverter INV2 may be controlled by the same inverter-specific switching controller 8₂.

FIG. 3 is a schematic block diagram of an exemplary embodiment of a switching controller 8₁ or 8₂ having switching control function 84 that includes a dedicated switching control module 841A, 841B, and 841C adapted to provide control signals, such as G₁, G₂, . . . , Gₙ to each phase leg U₁, V₁ and W₁, respectively, based on a respective PWM signal PWM_{U}, PWM_{V} and PWM_{W} received from a PWM modulator. The PWM modulator may be common for all parallel-connected inverters INV1 . . . . INVn (e.g., as a part of the higher-level control 86 in FIG. 1, and the PWM commands may be sent via a communication link to the inverters. In embodiments, a leg-specific output current sensing and/or a leg-specific inductor voltage sensing feedback FD may be provided for each leg-specific switching control module 841A, 841B, and 841C. In embodiments, a leg-specific current balancing may be included in the switching control 84, and particularly in the leg-specific switching control modules 841A, 841B, and 841C. In embodiments, a leg-specific current balancing may be implemented by means of Field Programmable Gate Arrays (FPGAs).

Referring again to FIG. 2, the exemplary half-bridge power section 10 of the inverter INV1 illustrated in FIG. 2 includes a pair of main or power switching devices S₁₁ and S₂₁ coupled in parallel to the dc-link rails 22 and 24. The first (upper) main switching device S₁₁ may have a first terminal electrically coupled to the positive dc-link rail 22 and a second terminal electrically coupled to an output node 110. The second (lower) main switching device S₂₁ having a first terminal coupled to output node 110 and a second terminal coupled to the negative dc-link rail 24. Across the upper main switching device S₁₁ between the positive dc-link rail 22 and the output node 110 is connected a first antiparallel diode D₁₁, and across the lower main switching device S₂₁ between the output node 110 and the negative dc-link rail 24 is connected a second antiparallel diode D₂₁. The upper main switching device S₂₁ is operable to turn on and turn off, and thereby to respectively connect and disconnect the dc-link rail 22 and the output node 110, in response to control signal(s) G₁₁ received from a control and driver circuitry, such as an inverter-specific switching controller 8₁ illustrated in FIG. 2. The lower main switching device S₂₁ is operable to turn on and turn off, and thereby to respectively connect and disconnect the dc-link rail 24 and the output node 110, in response to control signal(s) G₂₁ received from the control and driver circuitry, such as the switching controller 8₁. Similarly, the exemplary half-bridge power section 10A of the inverter INV2 illustrated in FIG. 2 includes a pair of main or power switching devices S₁₂ and S₂₂, a first antiparallel diode D₁₂, a second antiparallel diode D₂₂, and switching control signals G₁₂ and G₂₂ from a control and driver circuitry, such as an inverter-specific switching controller 8₂. In embodiments, the switching devices S₁₁, S₁₂, S₂₁ and S₂₂ may be insulated gate bipolar transistors (IGBT), or other type of semiconductor switching devices, such as integrated gate-commutated thyristors (IGCT), metal-oxide-semiconductor field-effect transistors (MOSFET), or silicon carbide (SIC) MOSFETs to name several examples.

In operation, when the output current Iₒ is positive (Iₒ₁>0, Iₒ₂>0) and the upper main switch S₁₁/S₁₂ is turned on (to a conductive state), a first switch current Iₛ₁₁/Iₛ₁₂ can flow between the dc-link rail 22 and the output node 110. Similarly, when the output current Iₒ is negative (Iₒ₁<0, Iₒ₂<0) and the lower main switching device S₂₁/S₂₂ is turned on (to a conductive state), a second switch current Iₛ₂₁/Iₛ₂₂ can flow between the output node 110 and the dc-link rail 24. On the other hand, when the upper switching device S₁₁/S₁₂ is turned off (to a non-conductive state), the first switch current Iₛ₁₁/Iₛ₁₂ will not flow in the switch-forward direction between the dc-link rail 22 and the output node 110, although a current I_{d11}/I_{d12} may flow in the switch-reverse direction through the first anti-parallel diode D₁₁/D₁₂ of the upper main switching device S₁₁/S₁₂, if the output current Io is negative (Iₒ₁<0, Iₒ₂<0). Similarly, when the lower main switching device S₂₁/S₂₂ is turned off (to a non-conductive state), the second switch current Iₛ₂₁/Iₛ₂₂ will not flow in the switch-forward direction between the output node 110 and the dc-link rail 24, although a current I_{d21}/I_{d22} may flow in the switch-reverse direction through the anti-parallel diode D₂₁/D₂₂ of the lower switching device S₂₁/S₂₂, if the output current Iₒ is positive (Iₒ₁>0, Iₒ₂>0). Thus, by turning on and off and closing the upper main switching device S₁₁/S₁₂ and the lower main switching device S₂₁/S₂₂, the output voltage at the output node 110 will be controlled or commutated to be either the potential P from the dc-link rail 22 or the potential N from the dc-link rail 24.

More specifically, when the output current Iₒ is positive (Iₒ₁>0, Iₒ₂>0), it is the upper switches S₁₁ and S₁₂ that commutate their currents (Iₛ₁₁ and Iₛ₁₂, respectively) to diodes D₂₁ and D₂₂, respectively, and the output voltage Uₒ swings from the potential P (the dc-link 22) to the potential N (the dc-link 24). When the output current Io is negative (Iₒ₁<0, Iₒ₂<0), it is the lower switches S₂₁ and S₂₂ that commutate their currents (Iₛ₂₁ and Iₛ₂₂, respectively) to diodes D₁₁ and D₁₂, respectively, and the output voltage Uₒ swings from the potential N (the dc-link 24) to the potential P (the dc-link 22).

The commutation for a corresponding phase in the plurality of parallel-connected inverters, e.g., for the phase U₁ of the inverter INV1 and the phase U₂ of the inverter INV2, can be initiated by similar commutation commands at the same time instant. In an ideal case, the output currents Iₒ₁ and Iₒ₂ of the parallel-connected inverters would be equal and their difference or a differential output current I_{do} would be zero, (e.g., I_{do}=Iₒ₁−Iₒ₂=0). However, the ideal behavior during commutations would require that the corresponding switches, e.g., upper switches S₁₁ and S₁₂, in the parallel operated inverters turn on at the same instant when commutating the output potential Uₒ, for example from N to P. Likewise, the corresponding switches, e.g., upper switches S₁₁ and S₁₂, in the parallel operated inverters should turn off at the same instant when commutating the output potential, for example from P to N. Unfortunately, the parallel operated inverters do not behave similarly, for example due to parameter differences of switch components and differing impedances in parallel branches, the output currents from the parallel inverters can be unequal in magnitude, and a current difference, here defined as I_{do}=Iₒ₁−Iₒ₂≠0, will evolve. In other words, there can be uneven current sharing between the inverters. Due to thermal and economic reasons, it is of utmost importance that the parallel-connected inverters share the load current as evenly as possible.

According to an aspect of the invention, a current sharing between the parallel-connected inverter legs is balanced by means of adjusting switching instants of main switches of the parallel-connected inverter legs, by a control arrangement, such as the switching controls functions 84 or switching control module 841_{U}, 841_{V}, and 841_{W}. The control arrangement may sense the leg output current before and after a commutation in each of the parallel-connected inverter legs to obtain a pre-commutation current value and a post-commutation current value, and the control arrangement may adjust switching instants of the main switches for next commutation autonomously in each of the parallel-connected inverter legs based on a difference between the pre-commutation and the post-commutation current values of the respective parallel-connected inverter leg to control the difference towards zero, the difference being representative of a timing difference and/or a commutation-induced current difference between the respective parallel-connected inverter leg and at least one of the other parallel-connected inverter legs. Thereby, the control arrangement can balance the current sharing by fine tuning the switching instants which may otherwise be generated in a conventional manner.

Let us examine the situation for a case where the output current Iₒ is positive (Iₒ₁>0, Iₒ₂>0) in the exemplary inverter system shown in FIG. 2, i.e., the upper switches S₁₁ and S₁₂ commutate their currents (Iₛ₁₁ and Iₛ₁₂, respectively) to diodes D₂₁ and D₂₂, respectively.

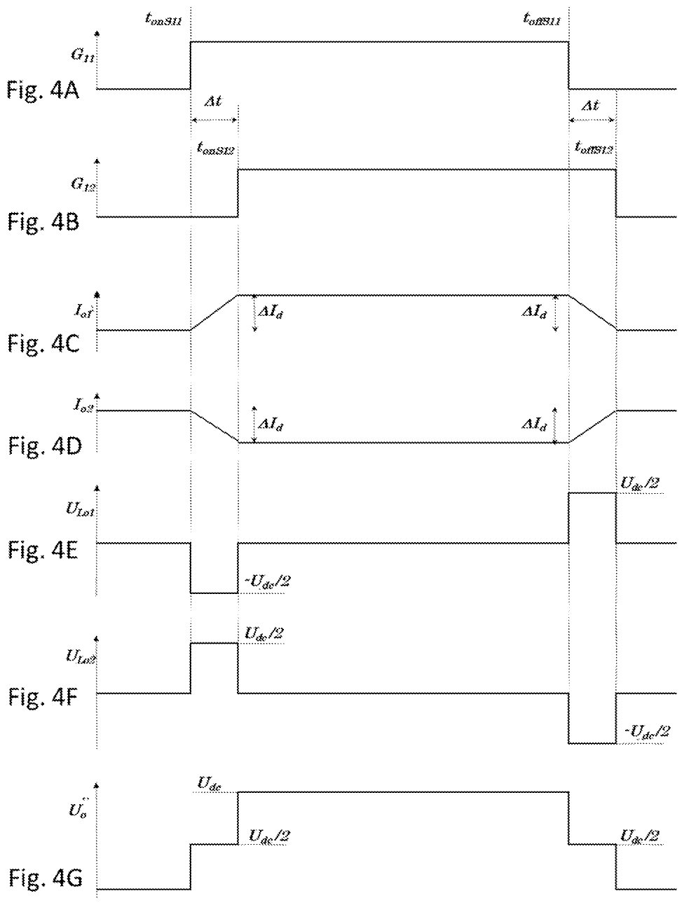

FIGS. 4A-4F illustrate an example of principal wave forms for the gate control signals G₁₁ and G₁₂ at turn-on and turn-off off for upper switches S₁₁ and S₁₂ of both half-bridges, together with corresponding current and voltage wave forms of Io₁, Io₂, U_{L1} and U_{L2}. An example of a principal wave form of the output voltage Uₒ of the inverter system, referred to N potential is also shown in FIG. 4G. In FIG. 4A, the gate signal G₁₁ causes the upper switch S₁₁ to turn on (N to P commutation) at a turn-on instant t_{onS11} and to turn off (P to N commutation) at turn-off instant t_{offS11}. Similarly, in FIG. 4B, the gate signal G₁₂ causes the upper switch S₁₂ to turn on (N to P commutation) at a turn-on instant t_{onS12} and to turn off (P to N commutation) at turn-off instant t_{offS12}.

Let us also define the timing difference Δt of the parallel-connected inverter legs for turn-on and turn-off as

$$Δ {t}_{on} = {t}_{onS 12} - {t}_{onS 11} \qquad ( 1 )$$

$$Δ {t}_{off} = {t}_{offS 12} - {t}_{offS 11} \qquad ( 2 )$$

wherein
t_{onS11} is a turn-on instant of S₁₁
t_{onS12} is a turn-on instant of S₁₂
t_{offS11} is a turn-off instant of S₁₁
t_{offS12} is a turn-off instant of S₁₂.

If there is a difference of magnitude Δt in either the turn-on instants or the turn-off instants of the upper switches S₁₁ and S₁₂, a differential current increment ΔI_{d} will be induced into the circuit, as illustrated in FIGS. 4C and 4D. The increment ΔI_{d} is the change of the differential current I_{d} during the commutation. The magnitude of the increment will be

$$Δ {I}_{d} = \frac{Δ {tU}_{dc}}{{L}_{o 1} + {L}_{o 2}} \qquad ( 3 )$$

wherein
Δt is Δtₒₙ or Δt_{off}
U_{dc} is the dc link voltage (known or measured)
Lₒ₁ and Lₒ₂ are output inductances.

It can be seen in equation (3) that the differential current increment ΔI_{d} is directly proportional to the timing difference Δt. The sign of ΔI_{d} in the parallel-connected inverter leg INV1 will depend on whether ΔI_{d} was during turn-on or turn-off of the switches, and whether S₁₁ was switching earlier or later than S₁₂ (i.e., the sign of Δt) as shown in Table I below. Similarly, the sign of of ΔI_{d} in the parallel-connected inverter leg INV2 for S₁₂ is shown in Table II below. It can be seen that the sign of ΔI_{d} and the sign of Δt in one of the parallel-connected inverter legs INV1 and INV2 are opposite to those in the other one of the parallel-connected inverter legs INV1 and INV2. The Tables I and II represent the same situation but from perspective of different inverter INV1 and INV2, respectively. The top row of Table I and bottom row of Table II describe the same situation and they have opposite polarity for the differential current increment ΔI_{d}. Same applies for bottom row of Table I and top row of Table II. Similar tables can be readily provided for a case where the output current Iₒ is negative (Iₒ₁<0, Iₒ₂<0) in the exemplary inverter system shown in FIG. 2, i.e., the lower switches S₂₁ and S₂₂ commutate their currents (Iₛ₂₁ and Iₛ₂₂, respectively) to upper diodes D₁₁ and D₁₂, respectively.

TABLE I

| | Turn-on | Turn-off |
|---|---|---|
| INV1 | (Uₒ from N to P) | (Uₒ from P to N) |
| S₁₁ turns on or off before | ΔI_{d} > 0 | ΔI_{d} < 0 |
| S₁₂ (Δtₒₙ > 0 or Δt_{off} > 0) | | |
| S₁₁ turns on or off after | ΔI_{d} < 0 | ΔI_{d} > 0 |
| S₁₂ (Δtₒₙ < 0 or Δt_{off} < 0) | | |

TABLE II

| | Turn-on | Turn-off |
|---|---|---|
| INV2 | (Uₒ from N to P) | (Uₒ from P to N) |
| S₁₂ turns on or off before | ΔI_{d} > 0 | ΔI_{d} < 0 |
| S₁₁ (Δtₒₙ > 0 or Δt_{off} > 0) | | |
| S₁₂ turns on or off after | ΔI_{d} < 0 | ΔI_{d} > 0 |
| S₁₁ (Δtₒₙ < 0 or Δt_{off} < 0) | | |

In the example shown in FIGS. 4A-4G, the switch S₁₁ is early to turn on and early to turn off relative to the switch S₁₂. Thus, in the leg INV1, the leg output current Iₒ₁ increases by ΔI_{d} (ΔI_{d}>0) at turn-on of S₁₁ and decreases by ΔI_{d} (ΔI_{d}<0) at turn-off of S₁₁ (FIG. 4C). In the leg INV2, the leg output current I₂ decreases by ΔI_{d} (ΔI_{d}<0) at turn-on of S₁₂ and increases by ΔI_{d} (ΔI_{d}>0) at turn-off of S₁₂ (FIG. 4D). For simplicity, the timing difference Δt is drawn to be as long both in turn-on and turn-off in FIGS. 4A-4G so that in this example the differential current changes cancel each other out. If the timing differences Δt at turn-on and turn-off were not equal in durations, the changes would not cancel each other.

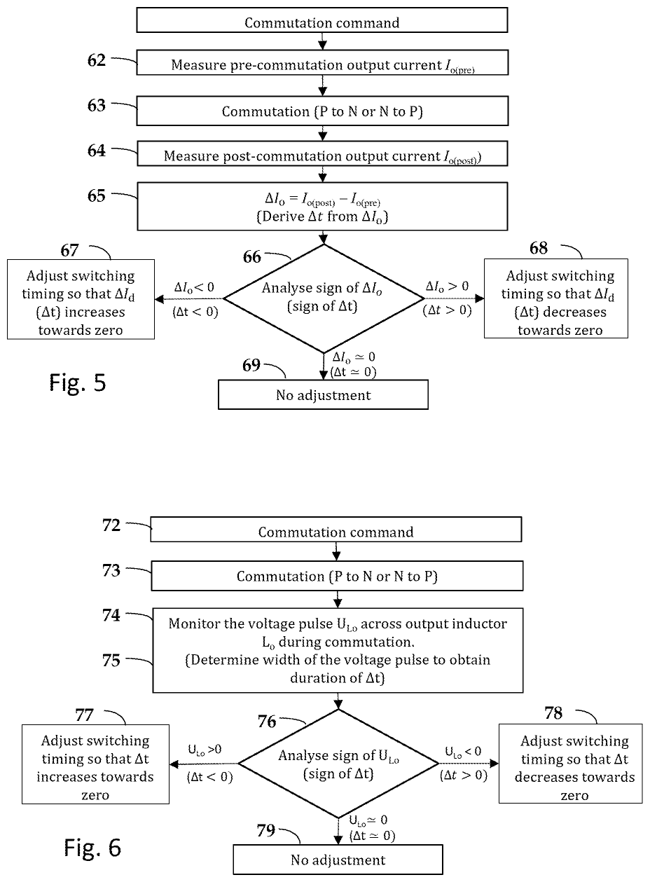

In embodiments, each parallel-connected inverter leg (INV1, INV2, . . . , INVn), preferably the corresponding switching control (8₁, 8₂, . . . , 8ₙ) thereof, is arranged to sense or measure its leg output current (Iₒ₁, Iₒ₂, . . . , I₀ₙ) before (step 62 in FIG. 5) and after (step 64) the commutation (step 63) to obtain a pre-commutation output current sample (Iₒ₁₍ₚᵣₑ₎, Iₒ₂₍ₚᵣₑ₎, . . . , Iₒₙ₍ₚᵣₑ and a post-commutation output current sample (Iₒ₁₍ₚₒₛₜ₎, Iₒ₂₍ₚₒₛₜ₎, . . . , Iₒₙ₍ₚₒₛₜ₎). This way each parallel-connected inverter leg (INV1, INV2, . . . , INVn), preferably the switching control (8₁, 8₂, . . . , INVn) thereof, can acquire the increment ΔI_{d} as differences ΔIₒ₁=Iₒ₁₍ₚₒₛₜ₎−Iₒ₁₍ₚᵣₑ₎, ΔIₒ₂=Iₒ₂₍ₚₒₛₜ₎−Iₒ₂₍ₚᵣₑ₎, . . . , ΔIₒₙ=Iₒₙ₍ₚₒₛₜ₎−Iₒₙ₍ₚᵣₑ₎, respectively (step 65). The sign of the difference ΔIₒ₁, ΔIₒ₂, . . . , ΔIₒₙ in each parallel-connected inverter leg will indicate the sign of the timing difference Δt in the respective leg, i.e., whether the switching instant of the respective parallel-connected inverter leg is earlier or later relative to a corresponding switching instant of at least one of the other parallel-connected inverter legs.

Further, the differences ΔIₒ₁, ΔIₒ₂, . . . , ΔIₒₙ will be of opposite sign in the parallel-connected inverters having a timing difference, as illustrated in Tables I and II. Hence, based on the sign of the difference ΔIₒ₁, ΔIₒ₂, . . . , ΔIₒₙ (or the sign of Δt) in the respective parallel-connected leg (step 66), each parallel-connected inverter INV1, INV2, . . . , INVn can deduce that its own Δt must have been positive (>0) (e.g., its timing has been early) or its Δt must have been negative (<0) (e.g., its timing has been late). Each parallel-connected inverter leg INV1, INV2, . . . , INVn can now make an adjustment to its turn-off instant t_{off} or turn-on instant tₒₙ in such way that the adjustment either increases ΔI_{d} (Δt) from negative towards zero (step 67) or decreases ΔI_{d} (Δt) from positive towards zero (step 68). If the difference ΔIₒ (or Δt) is approximately zero, no timing adjustment may be needed (step 69). The sensing, analysis and adjustment is preferably carried out for each commutation event, i.e., every turn-on or turn-off of the switch (every N to P or P to N commutation). The adjusted t_{off} or tₒₙ can be used in in a subsequent (in the next, for example) turn-off or turn-on of the switch. In embodiments, the adjustments may be stored and further adjusted in the subsequent commutations, e.g., using an integral action controller. In embodiments, if a less optimal adjustment is satisfactory, sensing, analysis and adjustment may not be carried out for each commutation event as in an optimal adjustment but for a selective portion all commutations, such as for sequentially selected commutations, for certain commutations only, or for alternating commutations.

In embodiments, also a duration of the timing difference Δt can be estimated from the difference ΔIₒ₁, ΔIₒ₂, . . . , ΔIₒₙ (step 66 in FIG. 5), e.g., using equation (3). The duration of the timing difference Δt can be used in determining the amount of adjustment of the turn-off instant t_{off} or turn-on instant tₒₙ in the adjustment steps 67 and 68, for example.

The leg output currents Iₒ₁, Iₒ₂, . . . , Iₒₙ may be measured in various alternative ways obvious for a person skilled in the art, such as using a shunt current measurement or magnetic sensors. The pre-commutation current values Iₒ₁₍ₚᵣₑ₎, Iₒ₂₍ₚᵣₑ₎, . . . , Iₒₙ₍ₚᵣₑ and the post-commutation current values Iₒ₁₍ₚₒₛₜ₎, Iₒ₂₍ₚₒₛₜ₎, . . . , Iₒₙ₍ₚₒₛₜ₎ can be sampled either in an analogue circuit or a digital circuit. An existing current measurement needed for other control purposes in an inverter leg may also be used for the purposes of the present invention, if the filtering and limited sampling rate of the current did not deteriorate the useful signal for the extraction of Iₒ₍ₚₒₛₜ₎−Iₒ₍ₚᵣₑ₎.

According to an aspect of the invention, a control arrangement, such as the switching controls functions 84 or switching control module 841_{U}, 841_{V}, and 841_{W}, is configured to sense a voltage pulse over the leg output inductor in each of the parallel-connected inverter legs during the commutation, and the control arrangement is configured to adjust the switching instants autonomously in each of the parallel-connected inverter legs based on the duration and/or sign of the sensed output inductor voltage pulse or an integral of the voltage pulse of the respective parallel-connected inverter leg to control the magnitude and direction of a commutation-induced current difference towards zero. Thereby, the control arrangement can balance the current sharing by fine tuning the switching instants which may otherwise be generated in a conventional manner.

Referring to the exemplary inverter system shown in FIG. 2, the inverter leg INV1, INV2, . . . , INVn may monitor a voltage U_{Lo1}, U_{Lo2}, . . . , U_{Lon} (step 74 in FIG. 6) which is created across the output inductor Lₒ₁, Lₒ₂, . . . , Lₒₙ during commutation (step 73), if there is a timing difference Δt in the switching. As can be seen in FIGS. 4E and 4F, positive or negative voltage pulses U_{Lo1} and U_{Lo2} will be created across the inductors Lₒ₁ and Lₒ₂ of the inverter legs INV1 and INV2, respectively, due to a timing difference Δt The sign of voltage pulse U_{Lo1} or U_{Lo2} in the parallel-connected inverter leg INV1 or INV2 will depend on whether the voltage pulse was during turn-on or turn-off of the switches, and whether the switching in the respective parallel inverter leg earlier (Δt>0) or later (Δt<0) than the switching in the other parallel-connected inverter leg (i.e., the sign of Δt). Finally, the positive and negative differential current increments ΔI_{d} in the output currents Iₒ₁ and Iₒ₂ of the inverter legs INV1 and INV2, respectively, are formed as an integral of the inductor voltage pulses U_{Lo1} and U_{Lo2} over the timing difference Δt.

In the example shown in FIGS. 4A-4G, the switch S₁₁ is early to turn on and early to turn off relative to the switch S₁₂ (Δt>0). Thus, in the leg INV1, a negative voltage pulse U_{Lo1} is created across the inductor Lₒ₁ at turn-on of S₁₁ and a positive voltage pulse U_{Lo1} is created across the inductor Lₒ₁ at turn-off of S₁₁ (FIG. 4E), causing a positive ΔI_{d} (ΔI_{d}>0) at turn-on of S₁₁ and a negative ΔI_{d} (ΔI_{d}<0) at turn-off of S₁₁. In the leg INV2, a positive voltage pulse U_{Lo2} is created across the inductor Lₒ₂ at turn-off of S₁₂ and a negative voltage pulse U_{Lo2} is created across the inductor Lₒ₂ at turn-on of S₁₂ (FIG. 4F), causing a negative ΔI_{d} (ΔI_{d}<0) at turn-off of S₁₂ and a positive ΔI_{d} (ΔI_{d}>0) at turn-on of S₁₂.

Further, the voltages U_{Lo1}, U_{Lo2}, . . . , U_{Lon} will be of opposite sign in the parallel-connected inverters having a timing difference. Hence, based on the sign of the voltage U_{Lo1}, U_{Lo2}, . . . , U_{Lon} (or the sign of Δt) in the respective parallel-connected leg (step 76), each parallel-connected inverter INV1, INV2, . . . , INVn can deduce that its own Δt must have been positive (>0) (e.g., its timing has been early) or its Δt must have been negative (<0) (e.g., its timing has been late). Each parallel-connected inverter leg INV1, INV2, . . . , INVn can now make an adjustment to its turn-off instant t_{off} or turn-on instant tₒₙ in such way that the adjustment either increases ΔI_{d} (Δt) from negative towards zero (step 77) or decreases ΔI_{d} (Δt) from positive towards zero (step 78). If the voltage U_{Lo1}, U_{Lo2}, . . . , U_{Lon} (or Δt) is approximately zero, no timing adjustment may be needed (step 79). The monitoring, analysis and adjustment is preferably carried out for each commutation event, i.e., every turn-on or turn-off of the switch (every N to P or P to N commutation). The adjusted t_{off} or tₒₙ can be used in a subsequent (in the next, for example) turn-off or turn-on of the switch. In embodiments, the adjustments may be stored and further adjusted in the subsequent commutations, e.g., using an integral action controller. In embodiments, if a less optimal adjustment is satisfactory, sensing, analysis and adjustment may not be carried out for each commutation event as in an optimal adjustment but for a selective portion all commutations, such as for sequentially selected commutations, for certain commutations only, or for alternating commutations.

In embodiments, the duration of the timing difference Δt can also be acquired directly from the width or duration of the voltage pulse U_{Lo1}, U_{Lo2}, . . . , U_{Lon}. Therefore, a benefit of voltage measurement-based approach may be the speed and simplicity of measurement, as there is no need for a current sampling and indirect estimation of Δt from the ΔIₒ by means of equation (3), for example. The duration of the timing difference Δt can be used in determining the amount of adjustment of the turn-off instant t_{off} or turn-on instant tₒₙ in the adjustment steps 77 and 78, for example.

In embodiments, the voltage U_{Lo1}, U_{Lo2}, . . . , U_{Lon} may be integrated by an integrator circuit during the commutation to acquire a measure of ΔI_{d}. The measure of ΔI_{d} can be used in determining the amount of adjustment of the turn-off instant t_{off} or turn-on instant ton in the adjustment steps 77 and 78, for example.

The determination of the duration or width of the voltage pulse across the output inductor, and/or the integration of the voltage pulse across the output inductor can be implemented in an analogue or digital circuit. The voltage measurement-based approach could possibly be made faster and real-time with analogue electronics.

In embodiments, the timing adjustment may comprise postponing the turn-off instant t_{off} or the turn-on instant tₒₙ of the respective switch to decrease the current increment ΔI_{d} and/or the timing difference Δt towards zero, if the switch is switching early (Δt>0), and advancing the turn-off instant t_{off} or the turn-on instant tₒₙ of the respective switch to increase the current increment ΔI_{d} and/or the timing difference Δt towards zero, if the switch is switching early (Δt<0).

In embodiments, the timing difference Δt and/or the current increments ΔI_{d} in individual commutations are controlled by adjusting the switching instants so that the timing difference Δt and/or the current increment ΔI_{d} is not zero during commutations but stays bounded while an output voltage of the inverter system will swing in a stepwise manner.

In embodiments, the timing difference Δt and/or the current increments ΔI_{d} in individual commutations are controlled to a fixed non-zero value by adjusting the switching instants, the fixed non-zero value being equal in a turn-on commutation and a turn-off commutation. As a consequence, the differential current I_{d} jumps back and forth by ΔI_{d} but stays bounded. An example of a resulting behavior of the output voltage Uₒ of the inverter system is illustrated in FIG. 4G: the swings of the output voltage Uₒ from N to P and from P to N occur in a step wise manner. The stepwise swing of the output voltage may be beneficial in some applications. In motor drive applications, a stepwise output voltage fed to a motor winding, for example, would ease the stress on motor insulation and bearings.

In embodiments, the amount of adjustment of the turn-off instant t_{off} or the turn-on instant ton of the respective switch may be approximately half of the duration of the timing difference Δt. Because the adjustment is made to opposite directions in the two parallel-connected inverter legs, the total amount of adjustments will be approximately Δt, thereby cancelling the timing difference or the current difference between the two legs in subsequent commutations.

The switching control and timing adjustment techniques described herein may be implemented by various means. For example, these techniques may be implemented in hardware (one or more analog or digital and/devices), firmware (one or more devices), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) and executed by one or more processors/computers. The data storage medium or the memory unit may be implemented within the processor/computer or external to the processor/computer, in which case it can be communicatively coupled to the processor/computer via various means as is known in the art. Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

It will be obvious to a person skilled in the art that, as the technology advances, the inventive concept can be implemented in various ways. The invention and its embodiments are not limited to the examples described above but may vary within the scope of the claims.

1. A power inverter system, comprising:
two or more switching mode inverter legs connected in parallel between a common DC input and a common phase output to feed a phase output current to a common load, the phase output current being formed by combined leg output currents of the parallel-connected inverter legs, wherein commutations of the parallel-connected inverter legs are initiated by essentially simultaneous commutation commands,
a control arrangement configured to balance current sharing between the parallel-connected inverter legs by means of adjusting switching instants of main switches of the parallel-connected inverter legs,
wherein the control arrangement is configured to sense the leg output current before and after a commutation in each of the parallel-connected inverter legs to obtain a pre-commutation current value and a post-commutation current value, and wherein the control arrangement is configured to adjust switching instants of the main switches for subsequent commutation autonomously in each of the parallel-connected inverter legs based on a difference between the pre-commutation and the post-commutation current values of the respective parallel-connected inverter leg to control the difference towards zero, the difference being representative of a timing difference between switching instants of the respective parallel-connected inverter leg and at least one of the other parallel-connected inverter legs.

2. The power inverter system as claimed in claim 1, wherein, if a sign of the difference between the pre-commutation and the post-commutation current values is negative, the control arrangement is configured to adjust switching instants for subsequent commutation so as to increase the negative difference towards zero, and wherein, if a sign of the difference between the pre-commutation and the post-commutation current values is positive, the control arrangement is configured to adjust switching instants for subsequent commutation so as to decrease the positive difference towards zero.

3. The power inverter system as claimed in claim 1, wherein the sign of the difference between the pre-commutation and the post-commutation current values indicates whether the switching instant of the parallel-connected inverter leg is earlier or later relative to a corresponding switching instant of at least one of the other parallel-connected inverter legs, and wherein the control arrangement is configured to advance the switching instants of the main switch, if the sign of the difference between the pre-commutation and the post-commutation current values indicates the switching instant of the parallel-connected inverter leg is later relative to a corresponding switching instants of at least one other parallel-connected inverter leg.

4. The power inverter system as claimed in claim 1, wherein the control arrangement is configured to carry out the sensing and adjustment of the switching instants during all commutations or during a selected portion of the commutations.

5. The power inverter system as claimed in claim 1, wherein the control arrangement is configured to carry out the sensing at each turn-on and turn-off of the main switches.

6. The power inverter system as claimed in claim 1, wherein the control arrangement is configured to adjust the switching instants of the main switches to control the commutation-induced current difference or a timing difference in an individual commutation towards zero but not to zero thereby causing a stepwise swing of a phase output voltage of the inverter system during an individual commutation.

7. The power inverter system as claimed in claim 11, wherein the control arrangement is configured to adjust the switching instant of the main switches to control the commutation-induced current difference or a timing difference in an individual commutation towards zero to a non-zero value or to a predetermined non-zero value that is equal for turn-on and turn-off of the main switches, thereby causing a stepwise swing of a phase output voltage of the inverter system during an individual commutation.

8. The power inverter system as claimed in claim 1, wherein the control arrangement comprises a leg-specific controller for each of the two or more parallel-connected inverter legs to adjust the switching instants of the main switches.

9. The power inverter system as claimed in claim 1, wherein the power inverter system comprises two or more inverters, each of the inverters having one or more inverter phase legs, wherein the parallel-connected inverter legs are the corresponding inverter phase legs of the two or more inverters modules connected in parallel.

10. The power inverter system as claimed in claim 9, wherein the control arrangement comprises inverter-specific switching controllers for the two or more inverters, each of the inverter-specific switching controllers being configured to provide the autonomous adjustment of switching instants for each of the inverter phase legs of the respective inverter.

11. A power inverter system, comprising:
two or more switching mode inverter legs connected in parallel between a common DC input and, via leg output inductors, a common phase output to feed a phase output current to a common load, the phase output current being formed by combined leg output currents of the parallel-connected inverter legs, wherein commutations of the parallel-connected inverter legs are initiated by essentially simultaneous commutation commands,
a control arrangement configured to balance current sharing between the parallel-connected inverter legs by means of adjusting switching instants of main switches of the parallel-connected inverter legs,
wherein the control arrangement is configured to sense a voltage pulse over the leg output inductor in each of the parallel-connected inverter legs during the commutation, and wherein the control arrangement is configured to adjust the switching instants autonomously in each of the parallel-connected inverter legs based on the duration and/or sign of the sensed output inductor voltage pulse or an integral of the voltage pulse of the respective parallel-connected inverter leg to control the magnitude and direction of a commutation-induced current difference towards zero.

12. The power inverter system as claimed in claim 11, wherein the integral of the sensed voltage pulse represents a magnitude of the commutation-induced current difference in the parallel-connected inverter leg.

13. The power inverter system as claimed in claim 11, wherein the duration of the sensed voltage pulse represents a timing difference of a switching instant of the parallel-connected inverter leg relative to a corresponding switching instant of at least one other parallel-connected inverter leg.

14. The power inverter system as claimed in claim 11, wherein the sign of the sensed voltage pulse indicates whether the switching instant of the parallel-connected inverter leg is earlier or later relative to a corresponding switching instant of at least one other parallel-connected inverter leg.

15. The power inverter system as claimed in claim 11, wherein the control arrangement is configured to advance the switching instant of the parallel-connected inverter leg, if the sign of the voltage pulse indicates the switching instant of the parallel-connected inverter leg is later relative to a corresponding switching instant of at least one other parallel-connected inverter leg; and wherein the control arrangement is configured to delay the switching instant of the parallel-connected inverter leg, if the sign of the voltage pulse indicates the switching instant of the parallel-connected inverter leg is earlier relative to a corresponding switching instant of at least one other parallel-connected inverter leg.

16. The power inverter system as claimed in claim 11, wherein the control arrangement is configured to carry out the sensing and adjustment of the switching instants during all commutations or during a selected portion of the commutations.

17. The power inverter system as claimed in claim 11, wherein the control arrangement is configured to carry out the sensing at each turn-on and turn-off of the main switches.

18. The power inverter system as claimed in claim 11, wherein the control arrangement is configured to adjust the switching instants of the main switches to control the commutation-induced current difference or a timing difference in an individual commutation towards zero but not to zero thereby causing a stepwise swing of a phase output voltage of the inverter system during an individual commutation.

19. The power inverter system as claimed in claim 11, wherein the control arrangement is configured to adjust the switching instant of the main switches to control the commutation-induced current difference or a timing difference in an individual commutation towards zero to a non-zero value or to a predetermined non-zero value that is equal for turn-on and turn-off of the main switches, thereby causing a stepwise swing of a phase output voltage of the inverter system during an individual commutation.
